(19) United States
(12) Patent Application Publication
(10) Pub. No.: US 2014/0244372 A1
(43) Pub. Date: Aug. 28, 2014

(54) VALIDATING INTERNET AD CONVERSIONS

(71) Applicant: WAL-MART STORES, INC, Bentonville, AR (US)

(72) Inventor: David Patterson, Berkeley, CA (US)

(73) Assignee: Wal-Mart Stores, Inc, Bentonville, AR (US)

(21) Appl. No.: 13/780,381

(22) Filed: Feb. 28, 2013

(51) Int. Cl. G06Q 30/02

(52) U.S. Cl. CPC G06Q 30/0242
USPC 705/14.25; 705/14.34

(57) ABSTRACT

The present disclosure extends to methods, systems, and computer program products for selling advertising space for display of advertising on a website. A data broker, who controls a website, obtains information from customers, the information including identifying data, behavioral data, and demographic data concerning the customers. The data broker also obtains permission from the customers to provide this information to advertisers on the website and to track purchases made after receiving the advertising. The data broker then sells advertising space to advertisers and provides the advertisers with access to the customers' information. When the customers make purchases from the advertisers that can be attributed to the advertising, the data broker collects a payment from the advertisers and returns a portion of the payment to the customers. The customers benefit from this arrangement by receiving something in return for their purchases. The advertiser benefits by being able to target advertising to customers based on the information. The data broker benefits by collecting a payment for the sale of advertising space that is higher than would otherwise be possible.

### BACKGROUND

The internet is fueled by advertising, which typically falls into categories of CPM (pay per visitor view at very low prices), CPC (pay per click at substantially larger prices), and CPA (pay per conversion at premium prices). As used herein, “conversion” means completion of a purchase, a customer registration, or some other selected outcome as a result of the advertisement. Many advertisers have the third of these categories, CPA, as their goal, to pay for the advertising only when a specific selected result occurs. The CPA option offers the optimal advertising investment, but it is complicated in practice because it is well defined and relatively unambiguous only when a web visitor completes the process of “view, click, buy-or-register” within a few minutes. This is due to the uncertainty of identification of a visitor to a website who buys the advertised item days or weeks after viewing the advertisement. Google® AdWords® typically attributes a purchase by a putative identical visitor as a conversion when the purchase of the advertised product occurs within one month of viewing an ad. This is such a tentative relationship between the view of the advertisement and the selected result that CPA ads are rare despite being the most directly related to an ad's success.

These problems apply even with the use of computers and current computing systems. The disclosed methods and systems herein, provide efficient and cost effective methods and systems for merchants to obtain premium prices for selling advertising space on their websites. The disclosed methods, features, systems, and computer program products also operate to motivate customers to make purchases of the advertised products. Moreover, advertisers are motivated to advertise on the website because they have access to customer information that allows targeted advertising.

The present disclosure extends to methods, systems, and computer program products for selling advertising space for display of advertising on a website. A data broker, who controls a website, obtains information from customers, the information including identifying data, behavioral data, and demographic data concerning the customers. The data broker also obtains permission from the customers to provide this information to advertisers on the website and to track purchases made after receiving the advertising. The data broker then sells advertising space to advertisers and provides the advertisers with access to the customers' information. When the customers make purchases from the advertisers that can be attributed to the advertising, the data broker collects a payment from the advertisers and returns a portion of the payment to the customers. The customers benefit from this arrangement by receiving something in return for their purchases. The advertiser benefits by being able to target advertising to customers based on the information. The data broker benefits by collecting a payment for the sale of advertising space that is higher than would otherwise be possible.

The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 illustrates an example block diagram of a computing device;

FIG. 2 illustrates an example computer architecture that facilitates different implementations described herein;

FIG. 3 illustrates a flow chart of an example method according to one implementation.

### DETAILED DESCRIPTION

The present disclosure extends to methods, systems, and computer program products for providing merchant database updates for new product items. In the following description of the present disclosure, reference is made to the accompanying drawings, which form a part hereof, and in which is shown by way of illustration specific implementations in which the disclosure may be practiced. It is understood that other implementations may be utilized and structural changes may be made without departing from the scope of the present disclosure.

Implementations of the present disclosure may comprise or utilize a special purpose or general-purpose computer including computer hardware, such as, for example, one or more processors and system memory, as discussed in greater detail below. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures that can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. RAM can also include solid state drives (SSDs or PCIx based real time memory tiered Storage, such as FusionIO). Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. It should be noted that any of the above mentioned computing devices may be provided by or located within a brick and mortar location. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the disclosure can also be used in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, e.g., on-demand self-service, broad network access, resource pooling, rapid elasticity, measured service, or any suitable characteristic now known to those of ordinary skill in the field, or later discovered), service models (e.g., Software as a Service (SaaS), Platform as a Service (PaaS), Infrastructure as a Service (IaaS), and deployment models (e.g., private cloud, community cloud, public cloud, hybrid cloud, or any suitable service type model now known to those of ordinary skill in the field, or later discovered). Databases and servers described with respect to the present disclosure can be included in a cloud model.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the following description and Claims to refer to particular system components. As one skilled in the art will appreciate, components may be referred to by different names. This document does not intend to distinguish between components that differ in name, but not function.

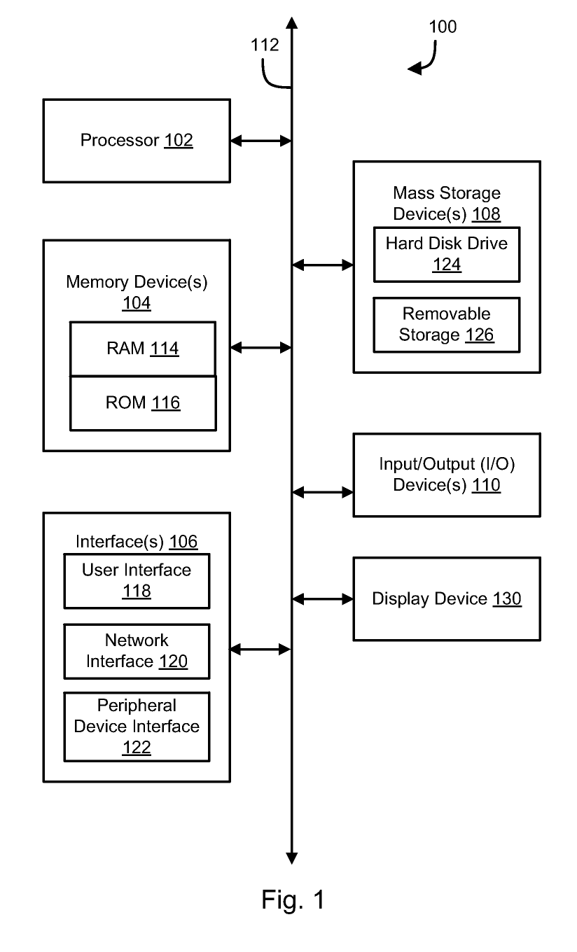

FIG. 1 is a block diagram illustrating an example computing device 100. Computing device 100 may be used to perform various procedures, such as those discussed herein. Computing device 100 can function as a server, a client, or any other computing entity. Computing device can perform various monitoring functions as discussed herein, and can execute one or more application programs, such as the application programs described herein. Computing device 100 can be any of a wide variety of computing devices, such as a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer-readable media, such as cache memory.

Memory device(s) 104 include various computer-readable media, such as volatile memory (e.g., random access memory (RAM) 114) and/or nonvolatile memory (e.g., read-only memory (ROM) 116). Memory device(s) 104 may also include rewritable ROM, such as Flash memory.

Mass storage device(s) 108 include various computer readable media, such as magnetic tapes, magnetic disks, optical disks, solid-state memory (e.g., Flash memory), and so forth. As shown in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, microphones, monitors or other display devices, speakers, printers, network interface cards, modems, lenses, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments. Example interface(s) 106 may include any number of different network interfaces 120, such as interfaces to local area networks (LANs), wide area networks (WANs), wireless networks, and the Internet. Other interface(s) include user interface 118 and peripheral device interface 122. The interface(s) 106 may also include one or more user interface elements 118. The interface(s) 106 may also include one or more peripheral interfaces such as interfaces for printers, pointing devices (mice, track pad, etc.), keyboards, and the like.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 100, and are executed by processor(s) 102. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

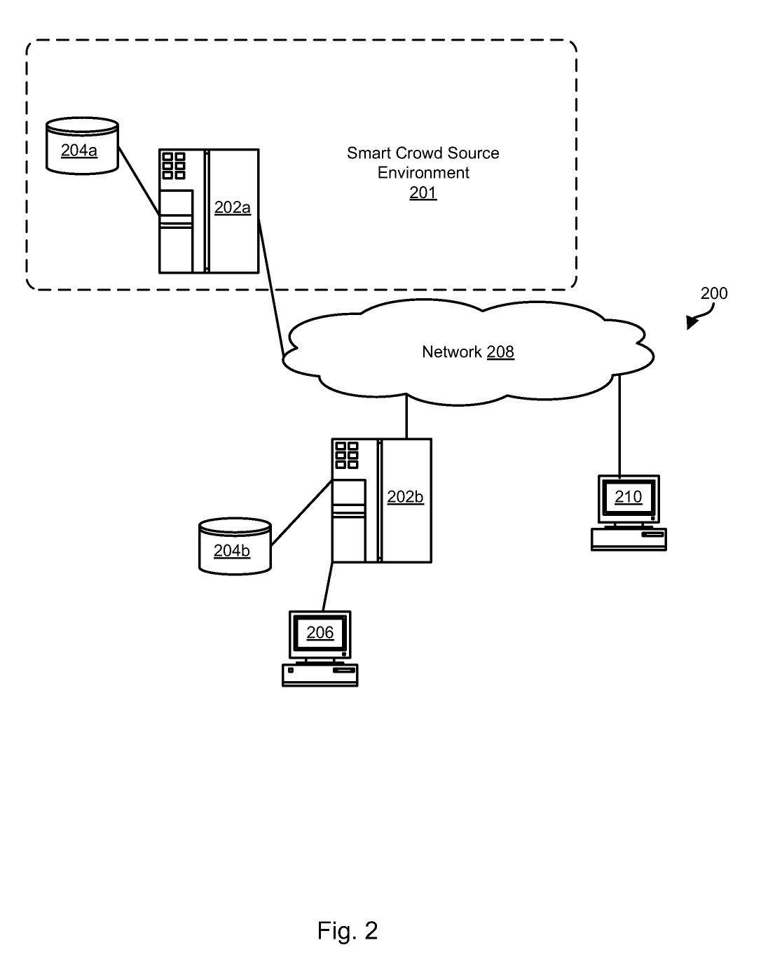

FIG. 2 illustrates an example of a computing environment 200 and a smart crowd source environment 201 suitable for implementing the methods disclosed herein. In some implementations, a server 202a provides access to a database 204a in data communication therewith, and may be located and accessed within a brick and mortar retail location. The database 204a may store customer attribute information such as a user profile as well as a list of other user profiles of friends and associates associated with the user profile. The database 204a may additionally store attributes of the user associated with the user profile. The server 202a may provide access to the database 204a to users associated with the user profiles and/or to others. For example, the server 202a may implement a web server for receiving requests for data stored in the database 204a and formatting requested information into web pages. The web server may additionally be operable to receive information and store the information in the database 204a.

As used herein, a smart crowd source environment is a group of users connected over a network that are assigned tasks to perform over the network. In an implementation the smart crowd source may be in the employ of a merchant, or may be under contract with on a per task basis. The work product of the smart crowd source is generally conveyed over the same network that supplied the tasks to be performed. In the implementations that follow, users or members of a smart crowd source may be tasked with reviewing the classification of new product items and the hierarchy of products within a merchant's database.

A server 202b may be associated with a classification manager or other entity or party providing classification work. The server 202b may be in data communication with a database 204b. The database 204b may store information regarding various products. In particular, information for a product may include a name, description, categorization, reviews, comments, price, past transaction data, and the like. The server 202b may analyze this data as well as data retrieved from the database 204a in order to perform methods as described herein. An operator or customer/user may access the server 202b by means of a workstation 206, which may be embodied as any general purpose computer, tablet computer, smart phone, or the like.

The server 202a and server 202b may communicate with one another over a network 208 such as the Internet or some other local area network (LAN), wide area network (WAN), virtual private network (VPN), or other network. A user may access data and functionality provided by the servers 202a, 202b by means of a workstation 210 in data communication with the network 208. The workstation 210 may be embodied as a general purpose computer, tablet computer, smart phone or the like. For example, the workstation 210 may host a web browser for requesting web pages, displaying web pages, and receiving user interaction with web pages, and performing other functionality of a web browser. The workstation 210, workstation 206, servers 202a-202b, and databases 204a, 204b may have some or all of the attributes of the computing device 100.

It is to be further understood that the phrase “computer system,” as used herein, shall be construed broadly to include a network as defined herein, as well as a single-unit work station (such as work station 206 or other work station) whether connected directly to a network via a communications connection or disconnected from a network, as well as a group of single-unit work stations which can share data or information through non-network means such as a flash drive or any suitable non-network means for sharing data now known or later discovered.

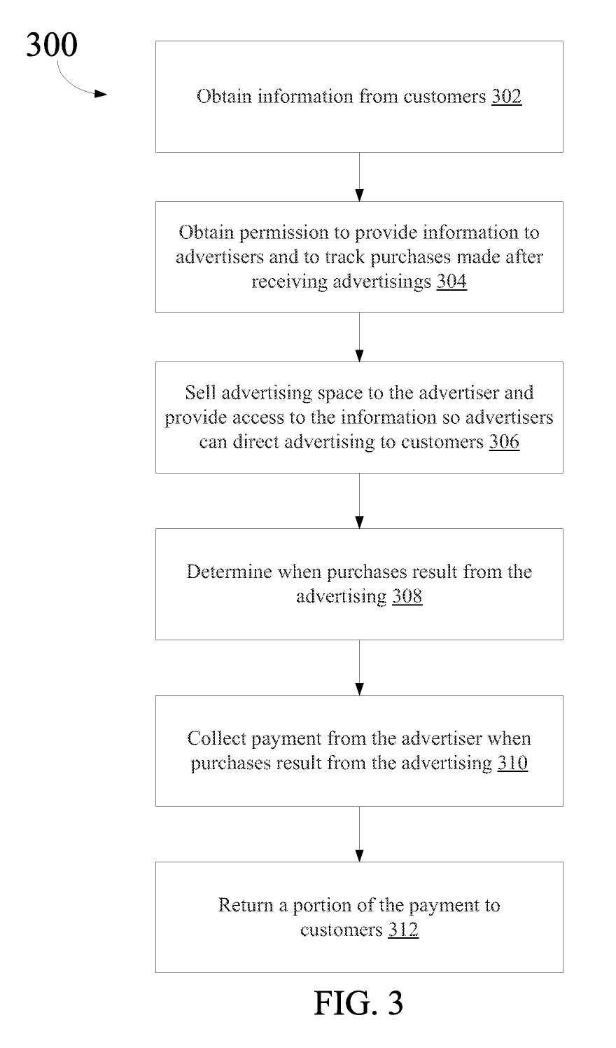

FIG. 3 is a flow chart of a method 300, according to an illustrative embodiment of the presently described and claimed invention, for selling advertising space for display of advertising on a website. A company, which can be thought of as a data broker, which controls a web site is well situated to utilize this method. The company is particularly well situated to utilize the method if its website receives a high volume of traffic due to the large number of products and services it offers on the website, the large number of customers it services, and if its reputation within the consuming public is that of a trusted source of quality merchandise. The company obtains 302 information from its customers, the information including identifying data, behavioral data, and demographic data. Identifying data can include name, address, telephone number, and email address. Usually, the identifying data are more useful the more information is obtained, but at least a name and verifiable email address would be needed. Behavioral data can include a wide variety of information, such as home ownership, recent purchases, recent internet searches, and the like. Demographic data can include gender, income level, marital status, number of children, age, educational level, and the like. Many more examples of behavioral data and demographic data are known in the art and can be used in the present method.

Of course, this information is useful to the company in marketing its own products and services, but in the instant context this information may be useful to advertisers who would want to purchase advertising space on the company's website. Many advertisers may be interested in purchasing advertising space on a company's website simply because the website receives a lot of traffic from users of the website. As explained above, fees paid by advertisers for views (CPM) or for clicks (CPC) are low to moderate. The company can charge higher fees for its advertising space if the company can charge for conversion of the advertising into results that the advertiser seeks (CPA), which can be actual purchases, customer registration, or some other outcome. The information obtained by the company is valuable to advertisers because it provides the advertisers the information needed to be able to target advertisements to selected segments of the consuming public.

The company will remain a trusted company in the eyes of consumers only if it obtains the consumers' permission to share this consumer information with advertisers. Therefore, the company obtains permission 304 from its customers to provide this information to the advertisers. Further, the company obtains permission 304 from its customers to track purchases that the customers make after receiving the advertisements.

The company then sells advertising space 306 to advertisers and provides the advertisers with the customer information, which the customers have given permission for the company to disclose. The advertisers may use this information in designing their advertisements and for targeting particular customers or segments of customers. For example, if the information revealed that a particular customer had recently purchased a boat, and the advertiser had products that would be of interest to boat owners, then the advertiser may decide to target that customer with advertisements relating to boating products.

Having obtained permission from the customers to track purchases made as a result of the advertising, the company proceeds to determine 308 when purchases of the advertiser's products can be attributed to the advertising. The company can track the purchases in at least a couple of ways. One way would be to keep track of the purchases on the company's own computers. Another way to accomplish the desired result would be to keep track of the purchases on cookies placed on the customers' computers. Both of these methods of tracking the purchases would be readily carried out according to methods well known in the art.

After the customers' purchases attributable to the advertising are determined to have taken place, the company then collects payment 310 from the advertiser for the advertisement having resulted in the desired outcome, namely, a purchase of advertised products. Some advertisers may have a different goal in mind than making a purchase. For example, some advertisers may want to have the customers register with the advertisers. In this case, the payment would be triggered when the customers register with the advertisers instead of when a purchase is made. Conceivably, other companies could have goals other than purchases or registering customers. In those instances, whatever the triggering event might be, the occurrence of the selected outcome would trigger the payment for the advertisement to the company.

The payment associated with successful conversion of a CPA advertisement should be substantially higher than what would be paid for a CPM or CPC advertisement. Currently, a payment for a CPM advertisement is a fraction of a cent per view. Similarly, a payment for a CPC advertisement is roughly ten cents per click, and a payment for a CPA advertisement is roughly one dollar per conversion. Due to the reliability of the presently described and claimed method, it is conceivable that the payment for conversion of an advertisement to the selected outcome could be multiples of what would be paid for prior art CPA advertisements, perhaps even ten dollars per conversion.

After the company collects the payment from the advertiser, then the company returns 312 a portion of the collected payment to the customers. Many ways are known to reward customers for various outcomes. For example, the company could rebate a portion of the collected payment to the customers in the form of cash, by means of a reward certificate that can be redeemed for cash or merchandise, or by means of other methods. This return of a portion of the payment to the customers provides an incentive for the customers to provide their information in the first place and also motivates them to make purchases of the advertisers' products. Thus, all three parties benefit from the arrangement. The customer benefits by receiving something in return for making purchases. The advertisers receive information that permits them to target customers with their advertising and also receive feedback about how effective their advertising is in providing a return in the form of purchases or other selected results. Moreover, the company receives a benefit by being able to charge higher fees for its advertising space.

The foregoing description has been presented for the purposes of illustration and description. It is not intended to be exhaustive or to limit the disclosure to the precise form disclosed. Many modifications and variations are possible in light of the above teaching Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

1. A method for selling advertising space for display of advertising on a website, the method comprising:
with a processor, obtaining information from customers, said information comprising identifying data, behavioral data, and demographic data concerning the customers;
with a processor, obtaining permission from the customers to provide said information to an advertiser who purchases advertising space on the website and to track when the customers make purchases after viewing said advertising;
with a processor, selling advertising space to the advertiser for display of advertising on the website, wherein the advertiser is provided with access to the information such that the advertiser can direct said advertising to said customers;
with a processor, determining when purchases made by said customers are a result of said advertising;
with a processor, collecting a payment from said advertiser when it is determined that purchases by said customers are a result of said advertising; and
with a processor, returning a portion of said payment to said customers.

2. The method of claim 1, wherein said identifying data comprises at least a name and a verifiable email address.

3. The method of claim 2, wherein said identifying data further comprises an address or a telephone number.

4. The method of claim 1, wherein said demographic data comprises a member selected from gender, income level, marital status, number of children, age, and educational level.

5. The method of claim 1, wherein said behavioral data comprises a member selected from home ownership, recent major purchases, and recent internet search requests.

6. The method of claim 1, wherein said portion of said payment is returned to customers by rebate.

7. The method of claim 1, wherein said portion of said payment is returned to customers by reward certificate.

8. The method of claim 1, wherein said determining when purchases made by said customers are a result of said advertising comprises recording said purchases in a database.

9. The method of claim 1, wherein said determining when purchases made by said customers are a result of said advertising comprises recording said purchases in customers' cookies.

10. A system for selling advertising space for display of advertising on a website comprising: one or more processors and one or more memory devices operably coupled to the one or more processors and storing executable and operational data, the executable and operational data effective to cause the one or more processors to:
obtain information from customers, said information comprising identifying data, behavioral data, and demographic data concerning the customers;
obtain permission from the customers to provide said information to an advertiser who purchases advertising space on the website and to track when the customers make purchases after receiving said advertising;
sell advertising space to the advertiser for display of advertising on the website, wherein the advertiser is provided with access to the information such that the advertiser can direct said advertising to said customers;
determine when purchases made by said customers are a result of said advertising;
collect a payment from said advertiser when it is determined that purchases by said customers are a result of said advertising; and
return a portion of said payment to said customers.

11. The system of claim 10, wherein said identifying data comprises at least a name and a verifiable email address.

12. The system of claim 11, wherein said identifying data further comprises an address or a telephone number.

13. The system of claim 10, wherein said demographic data comprises a member selected from gender, income level, marital status, number of children, age, and educational level.

14. The system of claim 10, wherein said behavioral data comprises a member selected from home ownership, recent major purchases, and recent internet search requests.

15. The system of claim 10, wherein said portion of said payment is returned to customers by rebate.

16. The system of claim 10, wherein said portion of said payment is returned to customers by reward certificate.

17. The system of claim 10, wherein the step to determine when purchases made by said customers are a result of said advertising comprises recording said purchases in a database.

18. The system of claim 10, wherein the step to determine when purchases made by said customers are a result of said advertising comprises recording said purchases in customers' cookies.
